(19) United States
(12) Patent Application Publication
(10) Pub. No.: US 2025/0100931 A1
(43) Pub. Date: Mar. 27, 2025

(54) POLYCARBOXYLIC ACID SLUMP RETAINING AGENT CONTAINING BLACK PHOSPHORUS QUANTUM DOT STRUCTURE AS WELL AS PREPARATION METHOD THEREFOR AND APPLICATION THEREOF

(71) Applicant: Anhui Conch Material Technology Co., Ltd., Wuhu City (CN)

(72) Inventors: Shanshan Qian, Wuhu City (CN); Feng Ding, Wuhu City (CN); Feng Jin, Wuhu City (CN); feng Chen, Wuhu City (CN); Jinying Peng, Wuhu City (CN)

(21) Appl. No.: 18/890,069

(22) Filed: Sep. 19, 2024

(30) Foreign Application Priority Data
Sep. 25, 2023 (CN) 2023112413216

(51) Int. Cl. C04B 24/32; B82Y 40/00; C04B 103/30; C08G 65/00

(52) U.S. Cl. CPC C04B 24/32; B82Y 40/00; C08G 65/00; C04B 2103/308

(57) ABSTRACT

The present invention provides a black phosphorus quantum dot modified polycarboxylic acid slump retaining agent as well as a preparation method therefor and an application thereof. By using a black phosphorus quantum dot (BPQDs-PEG-SH) with sulfydryl as a chain transfer agent to carry out a redox free radical polymerization reaction with an unsaturated polyether macromonomer and an unsaturated ester small monomer, the polycarboxylic acid slump retaining agent is grafted to a surface of the black phosphorus quantum dot (BPQDs). Compared with the prior art, the method of the present invention has the advantages that the number and length of branched chains are adjusted through the black phosphorus quantum dots with sulfydryl, the product performance is regulated and controlled, the reaction is rapid and highly efficient, no toxicity or pollution is caused, and the operation is simple. The prepared black phosphorus quantum dot modified polycarboxylic acid slump retaining agent has the advantages of retarding performance and stable product performance.

### FIELD OF TECHNOLOGY

The present invention belongs to the technical field of cement concrete and specifically relates to a polycarboxylic acid slump retaining agent containing a black phosphorus quantum dot structure as well as a preparation method therefor and an application thereof.

### BACKGROUND

Black phosphorus quantum dots (BPQDs) are a kind of nanomaterials with quasi-zero-dimensional structures, which have been widely concerned due to a large surface area, high chemical activity, a significant quantum confinement effect and an edge effect. Due to the quantum confinement effect, the black phosphorus quantum dots have discrete energy level structures, which are similar to atomic spectral properties. Meanwhile, due to the quantum confinement effect and the edge effect, the black phosphorus quantum dots have more excellent performance, and application fields of the black phosphorus quantum dots are greatly expanded by the development of black phosphorus quantum dots (BPQDs) technologies.

At present, the black phosphorus quantum dots (BPQDs) play a more and more important role in biomedicine, sensors, catalysts, photoelectric devices, detection analysis and other fields. When the black phosphorus quantum dots (BPQDs) are functionalized (modified or combined) with other functional substances, resulting BPQDs-based complexes and hybrid systems can be widely used in current active research fields, such as biological imaging, fluorescence sensing, ECL sensing, cancer therapy, etc., and have great application and development potential in these fields. Applications of the BPQDs with abundant active sites in the field of building materials have not been reported yet. Similar to other nanomaterials, the BPQDs have a potential application prospect.

At present, a large number of retarders used to improve the construction performance of concrete have certain defects. For example, white sugar causes waste of resources and has a high cost. Maltodextrin and cellulose derivatives are difficult to dissolve and easily have the phenomena of layering and the like after being compounded with a water reducing agent. Some inorganic phosphate retarders, such as sodium phosphate, will reduce the initial water reduction of concrete after being added, thereby accelerating the loss of concrete and increasing the ineffective loss of a water reducing agent. Organic phosphonate retarders, such as ATMP and HEDP, etc., have an excellent retarding effect, but have a high price.

In addition, with the development of modern concrete industry, polycarboxylic acid slump retaining agents are usually used for long-distance transportation under hot climate conditions, mass concrete construction, roller compacted concrete construction and high-temperature concrete operation for cementing of oil and gas wells, which have become an indispensable part of improving the working performance of concrete.

Therefore, it is necessary to provide a polycarboxylic acid slump retaining agent with simple preparation and good performance.

### SUMMARY

A purpose of the present invention is to provide a polycarboxylic acid slump retaining agent containing a black phosphorus quantum dot structure and a preparation method therefor. According to the method for preparing a black phosphorus quantum dot modified polycarboxylic acid slump retaining agent using a black phosphorus quantum dot and a redox free radical polymerization reaction, the polycarboxylic acid slump retaining agent is grafted to a surface of the black phosphorus quantum dot (BPQDs) to achieve excellent performance.

Another purpose of the present invention is to provide an application of a polycarboxylic acid slump retaining agent containing a black phosphorus quantum dot structure. The polycarboxylic acid slump retaining agent is applied to cement paste, mortar, or concrete.

Specific technical solutions of the present invention are as follows.

A polycarboxylic acid slump retaining agent containing a black phosphorus quantum dot structure has a structural formula as follows:

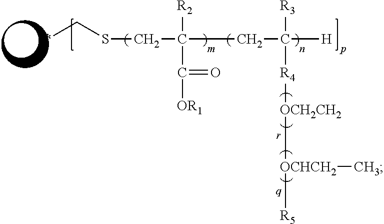

in the structural formula of the polycarboxylic acid slump retaining agent containing a black phosphorus quantum dot structure, R₁ is alkyl or hydroxyalkyl; R₂ is a combination of any one or more of H, alkyl containing 1-6 C atoms, or an aromatic group; R₃ is H or alkyl; R₄ is a combination of any one or more of alkyl, an alicyclic group, an aromatic group, or carbonyl; R₅ is hydroxyl or alkoxyl; polymerization degrees r and q are each independently 0-200, and polymerization degrees m and n are each independently 3-100; and p is equal to or greater than 1.

The R₁ is preferably alkyl or hydroxyalkyl, more preferably —CH₃, —CH₂CH₃, —CH₂CH₂CH₃, —CH₂CH₂CH₂CH₃, —CH₂CH₂OH, or —CH₂CH₂CH₂OH;
the R₂ is preferably H, —CH₃, —CH₂CH₃, —CH₂CH₂CH₃, or —CH₂CH₂CH₂CH₃;
the R₃ is preferably alkyl, more preferably H, —CH₃, or —CH₂CH₃;
the R₄ is preferably alkyl or carbonyl, more preferably —CH₂—, —CH₂—CH₂—, or

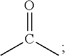

the R₅ is preferably hydroxyl or alkoxyl, more preferably —OH or —OCH₃; and
a weight-average molecular weight of the black phosphorus quantum dot modified polycarboxylic acid slump retaining agent is 20,000-80,000 g/mol.

A preparation method for a polycarboxylic acid slump retaining agent containing a black phosphorus quantum dot structure provided by the present invention specifically includes:
enabling an unsaturated polyether macromonomer, an unsaturated ester small monomer, a black phosphorus quantum dot with sulfhydryl, an oxidizing agent and a reducing agent to carry out a redox free radical polymerization reaction.

A molar ratio of the unsaturated polyether macromonomer, the unsaturated ester small monomer, the oxidizing agent, the reducing agent and the black phosphorus quantum dot with sulfhydryl is 1:(2-10):(0.01-0.1):(0.02-0.2):(0.03-0.3).

The unsaturated polyether macromonomer is represented by a structural formula

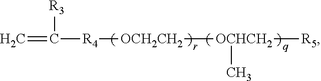

where R₃ is H or alkyl; R₄ is a combination of any one or more of alkyl, an alicyclic group, an aromatic group, or carbonyl; R₅ is preferably hydroxyl or alkoxyl; polymerization degrees r and q are each independently 0-200; a weight-average molecular weight of the unsaturated polyether macromonomer is 300-8,000 g/mol; and preferably, the unsaturated polyether macromonomer is a combination of one or more than two of methyl allyl polyoxyethylene ether, allyl polyoxyethylene ether, allyl polyethylene glycol monomethyl ether, methyl allyl polyethylene glycol monomethyl ether, isopentene polyoxyethylene ether, isopentene polyoxyethylene polyoxypropylene ether, polyethylene glycol acrylate, diethylene glycol monovinyl ether, or methoxy polyglycol glycol acrylate.

The unsaturated ester small monomer is represented by a structural formula

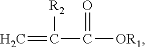

where R₁ is alkyl or hydroxyalkyl; R₂ is a combination of any one or more of H, alkyl containing 1-6 C atoms, or an aromatic group; and preferably, the unsaturated ester small monomer is a combination of one or more than two of methyl acrylate, ethyl acrylate, propyl acrylate, butyl acrylate, methyl methacrylate, ethyl methacrylate, butyl methacrylate, octyl acrylate, hydroxymethyl acrylate, hydroxyethyl acrylate, hydroxypropyl acrylate, hydroxyn-butyl methacrylate, or hydroxypropyl methacrylate.

The oxidizing agent is a combination of one or more than two of hydrogen peroxide, ammonium persulfate, sodium persulfate, or potassium persulfate.

The reducing agent is a combination of one or more than two of sodium bisulfite, sodium pyrosulfite, ferrous pyrophosphate, sodium sulfite, sodium formaldehyde sulfoxylate, ascorbic acid, sodium ascorbate, isoascorbic acid, or sodium hypophosphite.

The black phosphorus quantum dot with sulfhydryl is represented by a structural formula

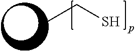

and is a sulfhydryl-polyethylene glycol modified black phosphorus quantum dot (BPQDs-PEG-SH), where p is equal to or greater than 1, and a weight-average molecular weight of PEG is 100-400 g/mol.

The reaction is carried out at 0-30° C., and a reaction time is 90-300 min.

Further, after the reaction is completed, water is added to obtain a polycarboxylic acid slump retaining agent containing a black phosphorus quantum dot structure with a concentration of 5-60 wt %.

In the present invention, the polycarboxylic acid slump retaining agent containing a black phosphorus quantum dot structure is synthesized by using the black phosphorus quantum dot and the redox free radical polymerization, a process is simple, the polycarboxylic acid slump retaining agent is endowed with new functions, and a new synthesis idea and a new slump retaining agent molecular structure are provided.

According to the application of the polycarboxylic acid slump retaining agent containing a black phosphorus quantum dot structure provided by the present invention, the polycarboxylic acid slump retaining agent is applied to cement paste, mortar, or concrete.

In the present invention, by using the black phosphorus quantum dot (BPQDs-PEG-SH) with sulfhydryl as a chain transfer agent and the redox free radical polymerization reaction, the polycarboxylic acid slump retaining agent is grafted to a surface of the black phosphorus quantum dot (BPQDs), and the polycarboxylic acid slump retaining agent with a similar spherical brush structure is synthesized. Compared with traditional polycarboxylic acid slump retaining agents, the polycarboxylic acid slump retaining agent containing a black phosphorus quantum dot structure has new properties: (1) the black phosphorus quantum dot in the structure can be degraded into a phosphate under alkaline conditions, which can inhibit a reaction of an alkali aggregate of concrete, enhance the impermeability and improve the durability of concrete; (2) the phosphate is generally used as a concrete retarder, which can prolong the retarding time of concrete and make the retention performance more excellent; and (3) the black phosphorus quantum dot is nano-sized and has an ultra-low friction coefficient and high wear resistance. When the polycarboxylic acid slump retaining agent containing a black phosphorus quantum dot structure is applied to concrete, the wear resistance of concrete is improved simultaneously. The research and development of the polycarboxylic acid slump retaining agent with a black phosphorus quantum dot (BPQDs) structure are a breakthrough in traditional water reducing agent technologies. The designability at a molecular structure level determines that a series of products with different performance characteristics or new structures having better performance can be developed to meet diversified requirements of construction projects for concrete admixtures. Certainly, the polycarboxylic acid slump retaining agent will have broad development potential and market prospects.

Compared with the prior art, the black phosphorus quantum dot modified polycarboxylic acid slump retaining agent provided by the present invention has abundant sources of utilized raw materials. The molecular structure of a product is regulated by different amounts of sulfhydryl on the black phosphorus quantum dot and the redox free radical polymerization to achieve excellent performance. The polycarboxylic acid slump retaining agent product prepared by the method of the present invention has retarding performance under the premise of not affecting slump retaining. Secondly, the black phosphorus quantum dot modified polycarboxylic acid slump retaining agent provided by the present invention can inhibit a reaction of an alkali aggregate, enhance the impermeability and improve the durability of concrete when applied to concrete. According to the present invention, a new synthesis idea is provided, and a new water reducing agent molecular structure is synthesized. A preparation process is safe and reliable, operation steps are simple and convenient, no toxicity or pollution is caused, and environmental safety is achieved.

### DESCRIPTION OF THE EMBODIMENTS

The technical solutions of the present invention are further described in detailed below through examples.

### Example 1

A preparation method for a polycarboxylic acid slump retaining agent containing a black phosphorus quantum dot structure is as follows.

At 30° C., 1 mol of methyl allyl polyethylene glycol monomethyl ether (300 g/mol), 10 mol of methyl methacrylate, 0.03 mol of a black phosphorus quantum dot with sulfhydryl

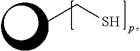

(p=1), 0.1 mol of hydrogen peroxide and 0.05 mol of sodium formaldehyde sulfoxylate were enabled to carry out a redox free radical polymerization reaction for 90 min, and water was added to obtain a black phosphorus quantum dot modified polycarboxylic acid slump retaining agent with a concentration of 60 wt % and a weight-average molecular weight of 20,000 g/mol.

The polycarboxylic acid slump retaining agent has a molecular structure of

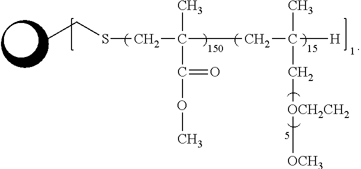

### Example 2

A preparation method for a polycarboxylic acid slump retaining agent containing a black phosphorus quantum dot structure is as follows.

At 10° C., 1 mol of methyl allyl polyoxyethylene ether (800 g/mol), 5 mol of ethyl acrylate, 0.05 mol of a black phosphorus quantum dot with sulfhydryl

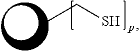

(p=2), 0.08 mol of ammonium persulfate and 0.1 mol of sodium sulfite were enabled to carry out a redox free radical polymerization reaction for 300 min, and water was added to obtain a black phosphorus quantum dot modified polycarboxylic acid slump retaining agent with a concentration of 50 wt % and a weight-average molecular weight of 30,000 g/mol.

The polycarboxylic acid slump retaining agent has a molecular structure of

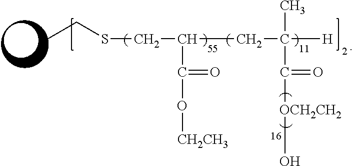

### Example 3

A preparation method for a polycarboxylic acid slump retaining agent containing a black phosphorus quantum dot structure is as follows.

At 20° C., 1 mol of isopentene polyoxyethylene ether (800 g/mol), 2 mol of propyl methacrylate, 0.1 mol of a black phosphorus quantum dot with sulfhydryl

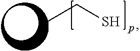

(p=3), 0.06 mol of sodium persulfate and 0.15 mol of sodium pyrosulfite were enabled to carry out a redox free radical polymerization reaction for 150 min, and water was added to obtain a black phosphorus quantum dot modified polycarboxylic acid slump retaining agent with a concentration of 40 wt % and a weight-average molecular weight of 50,000 g/mol.

The polycarboxylic acid slump retaining agent has a molecular structure of

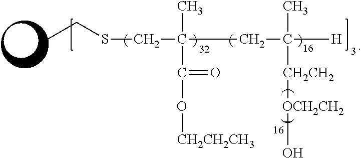

### Example 4

A preparation method for a polycarboxylic acid slump retaining agent containing a black phosphorus quantum dot structure is as follows.

At 15° C., 1 mol of isopentene polyoxyethylene polyoxypropylene ether (1,000 g/mol), 2 mol of methyl acrylate, 0.2 mol of a black phosphorus quantum dot with sulfhydryl

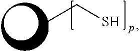

(p=4), 0.07 mol of potassium persulfate and 0.02 mol of sodium ascorbate were enabled to carry out a redox free radical polymerization reaction for 200 min, and water was added to obtain a black phosphorus quantum dot modified polycarboxylic acid slump retaining agent with a concentration of 30 wt % and a weight-average molecular weight of 60,000 g/mol.

The polycarboxylic acid slump retaining agent has a molecular structure of

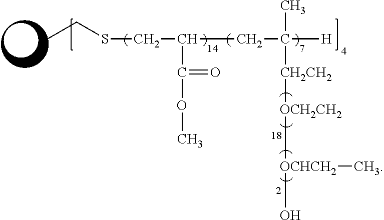

### Example 5

A preparation method for a polycarboxylic acid slump retaining agent containing a black phosphorus quantum dot structure is as follows.

At 5° C., 1 mol of isopentene polyoxyethylene ether (2,000 g/mol), 3 mol of hydroxyethyl acrylate, 0.3 mol of a black phosphorus quantum dot with sulfhydryl

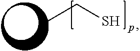

(p=3), 0.06 mol of sodium persulfate and 0.1 mol of sodium hypophosphite were enabled to carry out a redox free radical polymerization reaction for 180 min, and water was added to obtain a black phosphorus quantum dot modified polycarboxylic acid slump retaining agent with a concentration of 20 wt % and a weight-average molecular weight of 60,000 g/mol.

The polycarboxylic acid slump retaining agent has a molecular structure of

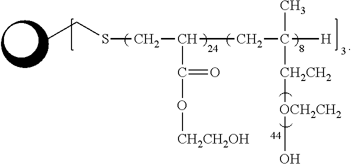

### Example 6

A preparation method for a polycarboxylic acid slump retaining agent containing a black phosphorus quantum dot structure is as follows.

At 10° C., 1 mol of polyethylene glycol methacrylate (1,200 g/mol), 4 mol of propyl acrylate, 0.08 mol of a black phosphorus quantum dot with sulfhydryl

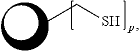

(p=5), 0.05 mol of hydrogen peroxide and 0.15 mol of vitamin C (ascorbic acid) were enabled to carry out a redox free radical polymerization reaction for 210 min, and water was added to obtain a black phosphorus quantum dot modified polycarboxylic acid slump retaining agent with a concentration of 10 wt % and a weight-average molecular weight of 80,000 g/mol.

The polycarboxylic acid slump retaining agent has a molecular structure of

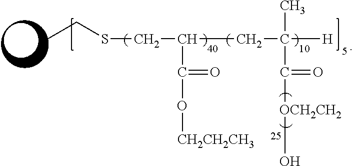

### Example 7

A preparation method for a polycarboxylic acid slump retaining agent containing a black phosphorus quantum dot structure is as follows.

At 20° C., 1 mol of methoxy polyethylene glycol acrylate (2,400 g/mol), 5 mol of butyl methacrylate, 0.1 mol of a black phosphorus quantum dot with sulfhydryl

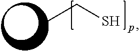

(p=4), 0.04 mol of potassium persulfate and 0.1 mol of sodium bisulfite were enabled to carry out a redox free radical polymerization reaction for 120 min, and water was added to obtain a black phosphorus quantum dot modified polycarboxylic acid slump retaining agent with a concentration of 5 wt % and a weight-average molecular weight of 45,000 g/mol.

The polycarboxylic acid slump retaining agent has a molecular structure of

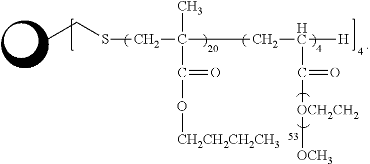

### Example 8

A preparation method for a polycarboxylic acid slump retaining agent containing a black phosphorus quantum dot structure is as follows.

At 30° C., 1 mol of isopentene polyoxyethylene polyoxypropylene ether (3,000 g/mol), 6 mol of hydroxypropyl methacrylate, 0.1 mol of a black phosphorus quantum dot with sulfhydryl

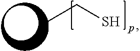

(p=5), 0.05 mol of hydrogen peroxide and 0.15 mol of ferrous pyrophosphate were enabled to carry out a redox free radical polymerization reaction for 90 min, and water was added to obtain a black phosphorus quantum dot modified polycarboxylic acid slump retaining agent with a concentration of 45 wt % and a weight-average molecular weight of 60,000 g/mol.

The polycarboxylic acid slump retaining agent has a molecular structure of

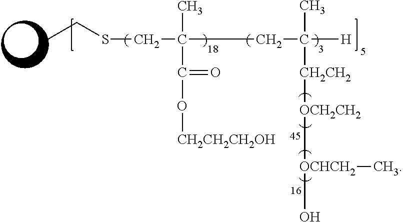

Cement paste fluidity and concrete tests are carried out on the polycarboxylic acid slump retaining agents containing a black phosphorus quantum dot structure prepared in various examples, which are specifically as follows.

Paste fluidity test: With reference to the GB8077-2000 “Methods for Testing Uniformity of Concrete Admixtures”, a paste fluidity test is carried out on samples obtained in Example 1 to Example 8. A water-cement ratio (W/C) is 0.29, a solid dosage of an admixture is 0.25% of a use amount of cement, and the paste fluidity has no loss within 5 hours.

TABLE 1
Paste fluidity and gradual loss of different samples

| | | Paste fluidity/mm | | | | |
|---|---|---|---|---|---|---|
| Sample | Dosage | 1 h | 2 h | 3 h | 4 h | 5 h |
| Example 1 | 0.25% | 107 | 195 | 236 | 216 | 196 |
| Example 2 | | 105 | 196 | 238 | 218 | 188 |
| Example 3 | | 100 | 205 | 249 | 226 | 186 |
| Example 4 | | 103 | 190 | 245 | 225 | 175 |
| Example 5 | | 100 | 200 | 259 | 239 | 159 |
| Example 6 | | 109 | 195 | 247 | 227 | 177 |
| Example 7 | | 100 | 205 | 257 | 237 | 167 |
| Example 8 | | 105 | 200 | 266 | 246 | 176 |

Concrete performance test: With reference to the GB8076-2008 “Concrete Admixtures”, the slump loss and concrete strength of the samples obtained in Example 1 to Example 8 are tested. When the solid dosage of an admixture is 2.0% (relative to the use amount of cement), the compressive strength is improved by more than 92% within 1 day, and the compressive strength is improved by more than 60% within 3 days.

TABLE 2
Concrete slump retaining performance and mechanical
performance of different samples

| | | | | | | Compressive | | |
|---|---|---|---|---|---|---|---|---|
| | | Slump (mm)/slump flow (mm) | | | | strength/MPa | | |
| Sample | Dosage | 1 h | 2 h | 3 h | 4 h | 1 d | 3 d | 7 d |
| Blank | 2.0% | — | — | — | — | 16.7 | 22.6 | 42.8 |
| sample | | | | | | | | |
| Example | | 150/— | 185/465 | 210/510 | 160/425 | 29.4 | 35.6 | 45.9 |
| 1 | | | | | | | | |
| Example | | 155/— | 180/455 | 205/515 | 155/415 | 29.1 | 35.9 | 46.1 |
| 2 | | | | | | | | |
| Example | | 145/— | 180/445 | 205/510 | 175/435 | 28.8 | 36.8 | 45.1 |
| 3 | | | | | | | | |
| Example | | 150/— | 190/465 | 205/520 | 165/410 | 29.6 | 37.6 | 44.9 |
| 4 | | | | | | | | |
| Example | | 160/415 | 195/475 | 210/525 | 160/415 | 29.3 | 38.7 | 45.8 |
| 5 | | | | | | | | |
| Example | | 140/320 | 185/455 | 210/530 | 170/420 | 28.8 | 37.9 | 46.1 |
| 6 | | | | | | | | |
| Example | | 155/310 | 200/470 | 205/500 | 185/430 | 27.9 | 36.9 | 45.9 |
| 7 | | | | | | | | |
| Example | | 145/— | 180/455 | 210/500 | 180/440 | 29.1 | 38.8 | 44.8 |
| 8 | | | | | | | | |

The polycarboxylic acid slump retaining agent containing a black phosphorus quantum dot structure provided by the present invention is applied to concrete, has retarding performance and stable product performance, has good slump retaining performance, and can improve the mechanical performance of concrete.

1. A polycarboxylic acid slump retaining agent containing a black phosphorus quantum dot structure, wherein the polycarboxylic acid slump retaining agent containing a black phosphorus quantum dot structure has a structural formula as follows: 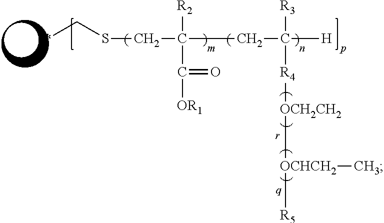
in the structural formula of the polycarboxylic acid slump retaining agent containing a black phosphorus quantum dot structure, R₁ is alkyl or hydroxyalkyl; R₂ is a combination of any one or more of H, alkyl containing 1-6 C atoms, or an aromatic group; R₃ is H or alkyl; R₄ is a combination of any one or more of carbonyl, —CH₂—, or —CH₂CH₂—; R₅ is hydroxyl or alkoxyl; polymerization degrees r and q are each independently 0-200, and polymerization degrees m and n are each independently 3-100; and p is equal to or greater than 1;
a preparation method for the polycarboxylic acid slump retaining agent containing a black phosphorus quantum dot structure comprises: enabling an unsaturated polyether macromonomer, an unsaturated ester small monomer, a black phosphorus quantum dot with sulfhydryl, an oxidizing agent and a reducing agent to carry out a redox free radical polymerization reaction;
a molar ratio of the unsaturated polyether macromonomer, the unsaturated ester small monomer, the oxidizing agent, the reducing agent and the black phosphorus quantum dot with sulfhydryl is 1:(2-10):(0.01-0.1):(0.02-0.2):(0.03-0.3; and
the black phosphorus quantum dot with sulfhydryl is represented by a structural formula 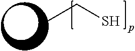
and is a sulfhydryl-polyethylene glycol modified black phosphorus quantum dot (BPQDs-PEG-SH), wherein p is equal to or greater than 1, and a weight-average molecular weight of PEG is 100-400 g/mol.

2. The polycarboxylic acid slump retaining agent containing a black phosphorus quantum dot structure according to claim 1, wherein a weight-average molecular weight of the polycarboxylic acid slump retaining agent containing a black phosphorus quantum dot structure is 20,000-80,000 g/mol.

3. A preparation method for the polycarboxylic acid slump retaining agent containing a black phosphorus quantum dot structure according to claim 1, wherein the preparation method comprises: enabling an unsaturated polyether macromonomer, an unsaturated ester small monomer, a black phosphorus quantum dot with sulfhydryl, an oxidizing agent and a reducing agent to carry out a redox free radical polymerization reaction; and
a molar ratio of the unsaturated polyether macromonomer, the unsaturated ester small monomer, the oxidizing agent, the reducing agent and the black phosphorus quantum dot with sulfhydryl is 1:(2-10):(0.01-0.1):(0.02-0.2):(0.03-0.3).

4. The preparation method according to claim 3, wherein the unsaturated polyether macromonomer is represented by a structural formula 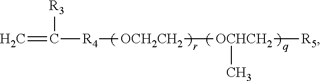
and R₃ is H or alkyl; R₄ is a combination of any one or more of carbonyl, —CH₂—, or —CH₂CH₂—; R₅ is hydroxyl or alkoxyl; polymerization degrees r and q are each independently 0-200; and a weight-average molecular weight of the unsaturated polyether macromonomer is 300-8,000 g/mol.

5. The preparation method according to claim 3, wherein the unsaturated polyether macromonomer is a combination of one or more than two of methyl allyl polyoxyethylene ether, allyl polyoxyethylene ether, allyl polyethylene glycol monomethyl ether, methyl allyl polyethylene glycol monomethyl ether, isopentene polyoxyethylene ether, isopentene polyoxyethylene polyoxypropylene ether, polyethylene glycol acrylate, or methoxy polyglycol glycol acrylate.

6. The preparation method according to claim 3, wherein the unsaturated ester small monomer is represented by a structural formula 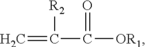
wherein R₁ is alkyl or hydroxyalkyl; and R₂ is a combination of any one or more of H, alkyl containing 1-6 C atoms, or an aromatic group.

7. The preparation method according to claim 3, wherein the unsaturated ester small monomer is a combination of one or more than two of methyl acrylate, ethyl acrylate, propyl acrylate, butyl acrylate, methyl methacrylate, ethyl methacrylate, butyl methacrylate, octyl acrylate, hydroxyethyl acrylate, hydroxypropyl acrylate, hydroxyn-butyl methacrylate, or hydroxypropyl methacrylate.

8. The preparation method according to claim 3, wherein the reaction is carried out at 0-30° C., and a reaction time is 90-300 min.

9. An application of the polycarboxylic acid slump retaining agent containing a black phosphorus quantum dot structure according to claim 1, wherein the polycarboxylic acid slump retaining agent is applied to cement paste, mortar, or concrete.
